(19) United States
(12) Patent Application Publication
(10) Pub. No.: US 2016/0335412 A1
(43) Pub. Date: Nov. 17, 2016

(54) SYSTEMS AND METHODS FOR PREDICTING AND ADJUSTING THE DOSAGE OF MEDICINES IN INDIVIDUAL PATIENTS

(71) Applicants: GEOFFREY TUCKER, SHEFFIELD (GB); AMIN ROSTAMI-HODJEGAN, SHEFFIELD (GB); STEVE TOON, CHARLESWORTH (GB)

(72) Inventors: GEOFFREY TUCKER, SHEFFIELD (GB); AMIN ROSTAMI-HODJEGAN, SHEFFIELD (GB); STEVE TOON, CHARLESWORTH (GB)

(21) Appl. No.: 14/164,828

(22) Filed: Jan. 27, 2014

Related U.S. Application Data
(60) Provisional application No. 61/758,579, filed on Jan. 30, 2013.

(51) Int. Cl. G06F 19/00; G06F 17/18; G06F 17/50

(52) U.S. Cl. CPC G06F 19/3437; G06F 17/5009; G06F 17/18

(57) ABSTRACT

The method and system of this invention provides for the use of the Simcyp Simulator to identify the characteristics of a Virtual Twin to a real patient based on physiological data and demographic characteristics of the real patient. The Virtual Twin can be used to estimate appropriate dosage levels for a real patient undergoing pharmaceutical treatment and to indicate drug interactions that can occur during the administration of multiple drugs.

Benefit of U.S. Provisional Application No. 61/758,579 filed on Jan. 30, 2013 is hereby claimed.

### BACKGROUND OF THE INVENTION

1. Field of the Invention

A system and method to use computerized, physiologically-based pharmacokinetic-pharmacodynamic models, as specifically embodied in the Simcyp Simulator®, provides guidance for the appropriate dosage of medicines to use for individual patients at the point-of-care.

2. Description of Related Art

### Definitions

In this patent disclosure, the following definitions are employed:

PHARMACOKINETICS refers to phenomena related to what the body does to a drug (the processes of drug absorption, distribution, metabolism and excretion), thereby determining the exposure of the patient to a drug concentration. The abbreviation PK will also be used.

PHARMACODYNAMICS refers to what the drug does to the body (biological changes and effects consequent to the interaction of a drug with specific biological receptors and targets that produce desired (therapeutic) and undesired (toxic) effects). The abbreviation PD will also be used.

Pharmacokinetic and Pharmacodynamics Background:

Both pharmacokinetic and pharmacodynamic processes are highly variable between patients, leading to quantitative differences in the response of individuals to a given drug dosage. The sources of pharmacokinetic variability relate to differences in demography (the impact of age, weight and race), physiology (differences in organ sizes, tissue composition, blood flows and the composition and transit of gut contents), enzymatic metabolism and biological transport of drugs (differences in tissue abundance and genetic expression of the proteins involved), and the impact of drug-drug interactions on metabolism and transport. In infants, for example, the ability to eliminate a drug will be highly dependent on the different rates of maturation (ontogeny) of drug metabolizing enzymes and transporters, while in the elderly variability will be compounded by multiple drug therapy associated with multiple diseases. Common diseases such as cancer, heart failure, morbid obesity and rheumatoid arthritis can all affect the handling of drugs by the body, as clearly will diseases of the main organs of drug elimination, the liver and the kidney.

According to a 2012 survey, 1 in 10 Americans take three or more prescription drugs and 1 in 20 take four or more, posing an escalating risk of complex, clinically significant drug-drug interactions (1).

Even in patients who are relatively healthy, genetic differences in the expression and activity of specific enzymes and biological transporters can contribute significantly to variability in pharmacokinetics. For example, 5-10% of Caucasians lack a functional enzyme called cytochrome P450 2D6 (CYP2D6), responsible for the metabolic clearance of, for example, many antidepressants and cardiovascular drugs (2). The frequencies of the so-called CYP2D6 ‘poor metabolizer’ geno/phenotype, and indeed those of other enzymes and transporters, also vary significantly across different racial groups, with implications for dosage modification in individuals.

In addressing individual patient variability when prescribing drugs doctors rely on their clinical experience and specific guidance on dosage and drug-drug interactions provided by the manufacturer's of medicines, national formularies and standard texts. Unfortunately, in many cases, a fixed dose is prescribed independent of patient characteristics, leading to under-dosing, resulting in a lack of efficacy, or over dosing, resulting in toxicity. Even when a dosage adjustment is made, this is difficult to do effectively in the face of co-morbidities and multiple co-medications. Consequently, avoidable adverse drug reactions (ADRs), including drug-drug interactions, are a frequent cause of consultation in primary care, admission to hospital and increased length of hospital stay (3,4). A prior art model of drug treatment is shown in FIG. 1. The patient seeks medical treatment or consultation and, based on clinical and laboratory assessment, the doctor prescribes a dosage of drug. Ideally, after a period of time the efficacy and safety of the dose are assessed and the dosage is adjusted. This loop may then be repeated until optimal therapy is achieved. Imprecision in this process relates to the competency of the individual doctor, his/her awareness of and ability to integrate the many sources of variability in pharmacokinetics and pharmacodynamics, and the changing condition of the patient with time. Any under- or overshoot in drug dosage is also likely to increase the chance of the patient not adhering to the drug therapy.

The Simcyp Simulator:

The Simcyp Simulator® is an advanced example of the embodiment and application of PBPK/PD (physiologically-based pharmacokinetic/pharmacodynamic) modeling in commercial software (5-7). By integrating system specific factors (including demography, genetics, race, disease organ sizes and blood flows, enzyme and transporter tissue abundances) with drug specific factors (including physical chemistry, in vitro data on enzyme and transporter kinetics, binding constants) (FIG. 2), and using specific models and equations defining processes such as hepatic and renal drug clearance, tissue partition, drug dissolution from oral dosage forms and subsequent absorption from different segments of the gastrointestinal tract, it simulates and predicts in vivo drug absorption, disposition and drug-drug interactions and response in virtual patient populations, for use in drug discovery and development. Based on demographic, physiological, biochemical and genetic information on specific populations (Caucasians, Japanese, Chinese, Africans, patients with liver cirrhosis, renal impairment, morbid obesity, cancer, rheumatoid arthritis, smokers, pregnant women, and neonates, infants and children), assessed from literature sources by meta-analysis, virtual populations have been constructed allowing for known correlation between variables using Monte Carlo simulation (FIG. 3). Exposure of these virtual populations to specific drugs (defined by their physical chemistry and in vitro information on their absorption and disposition) given in defined dosage regimens is modeled within the computer to predict population distributions of in vivo pharmacokinetic and pharmacodynamics outcomes. Drug response is assessed by linking the prediction of drug exposure from the PBPK model with an appropriate pharmacodynamic model, selected from a suite of such models representing different levels of complexity (threshold model, linear- and log-linear concentration-effect models, ordinary and sigmoid Eₘₐₓ (Hill) models, PK-PD link models, indirect response models, stimulus-response models, receptor binding models, as well as logistic, survival and disease progression models) (8). A specific example of an advanced pharmacodynamic model is a proprietary (Simcyp) systems biology model for the prediction of the risk of a specific form of cardiotoxicity, namely QT interval prolongation, mediated by interaction of a drug at the HERG channel in the cardiac cell (9).

Inter-individual variability reflects the net impact of prior variability assigned to each system and, where relevant, each drug specific factor. The accuracy of the predictions is verified by comparison with actual experimental data on plasma drug concentration-time and response-time profiles. In summary, the Simcyp Simulator® has the capability to identify the mix of characteristics that dispose to extremes of risk. It also offers the possibility of asking ‘what if’ questions in exploring complex clinical scenarios that may be difficult to study ethically (such as multiple drug-drug interactions in a neonate) within the safe confines of a computer simulation/analysis.

An example of the application of the Simcyp Simulator®, is its ability to evaluate the extent that the pharmacokinetics and, therefore, dosage of desipramine, a tricylic antidepressant, might differ in Caucasian and Chinese populations (10). To do this required the development of a specific Chinese population file, alongside the default population file for North European Caucasians. In constructing this file, demographic data compiled in The China Health and Nutrition Survey 2006 for 8118 male and female Han Chinese were simulated. A Weibull function was used to describe the age distribution in both sexes, and relationships between age, weight and height were derived by linear and non-linear regression analysis. Further data from published sources were incorporated in the file to account for liver volume in Chinese and other known differences from Caucasians, for example, in the abundance of drug metabolizing enzymes and their genetic expression, and the levels of plasma proteins that bind drugs. Compound files for over 70 drugs, including desipramine, are contained at this time within a Simcyp database. These files are constructed and curated by meta-analysis of published information on the binding of each compound to plasma proteins and red blood cells, and based on prediction of their tissue binding from physicochemical properties and tissue composition, and their enzyme and transporter kinetics derived from in vitro experiments with human hepatocytes, sub-cellular fractions of human liver, recombinant systems expressing specific enzymes and transporters, and specific cell systems such as Caco2 cells. A comparison of predicted and observed plasma concentrations of desipramine in Caucasian and Chinese subjects is shown in FIG. 4.

### DESCRIPTION OF THE FIGURES

FIG. 1. A schematic of a prior art system and method for prescribing medication to a patient. The physician assesses the patient and prescribes a drug at a certain dose and according to a certain dosage regimen. Consequently, the patient is reassessed and any dosage adjustment is made. This loop is repeated until safe and effective therapy is achieved or the drug is discontinued.

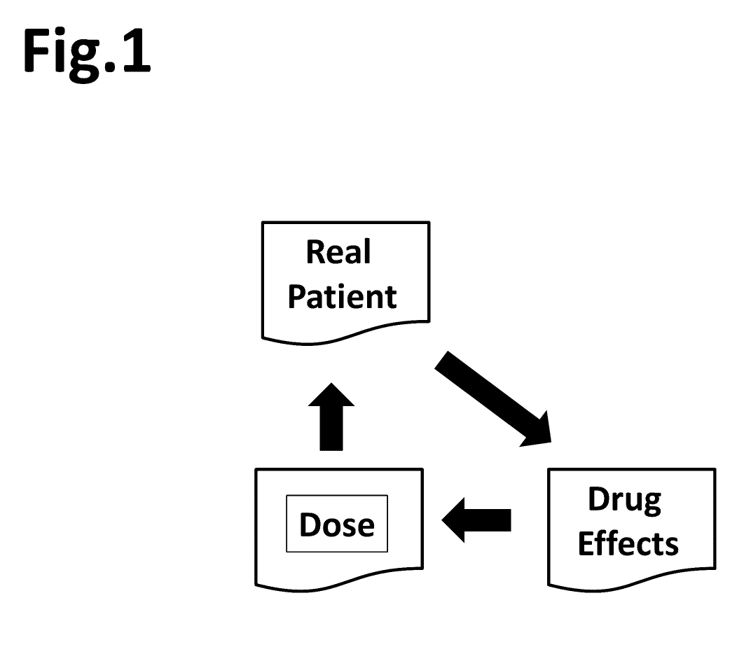

FIG. 2. System Pharmacokinetics—an area of pharmacology that integrates information on system specific factors (demography, physiology, genetics) with drug specific factors (physicochemical properties, in vitro data on binding to proteins, membrane permeability, and enzyme and transporter kinetics) to predict pharmacokinetic (PK) behavior (summarized by clearance (CL), volume of distribution (V), elimination half-life (t_{1/2}) and the likely extent of drug-drug interactions (DDI)), which can then be linked to pharmacodynamic (PD) outcomes.

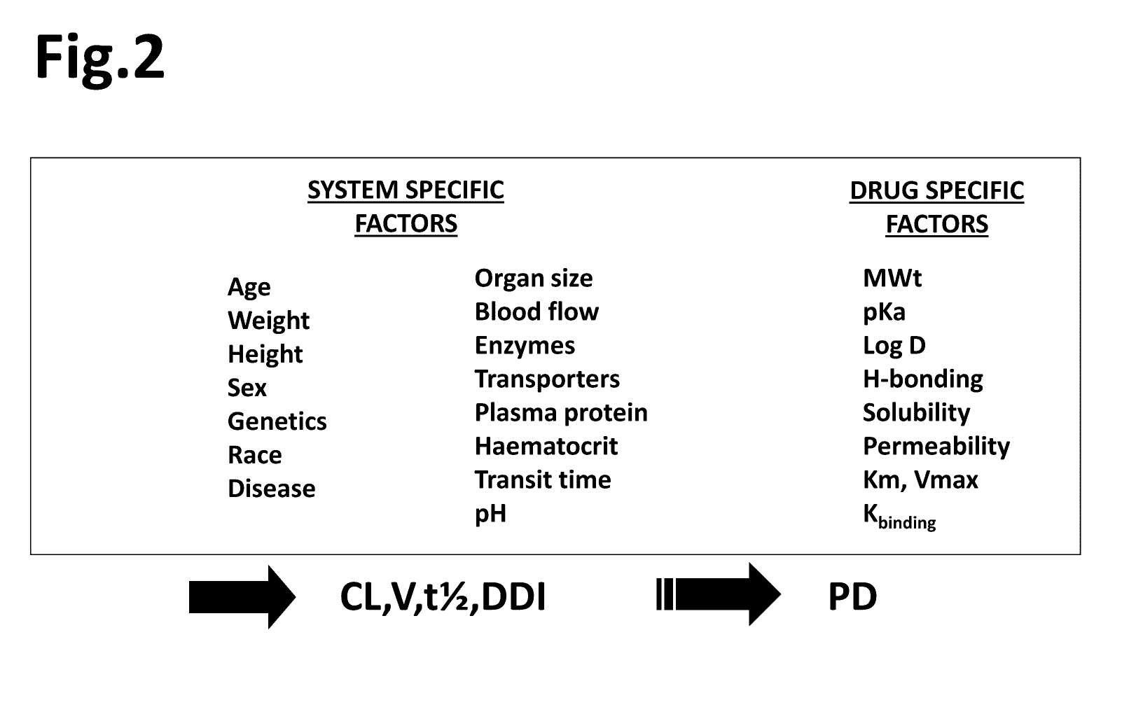

FIG. 3. Monte Carlo Simulation—is used to construct virtual populations, allowing for known correlations between demographic, physiological and biochemical variables.

FIG. 4. Prediction (lines) of observed (circles) plasma concentration-time profiles of desipramine (mostly metabolized by CYP2D6) in Chinese relative to Caucasian subjects after a single 100 mg oral dose (Barter et al, 2013).

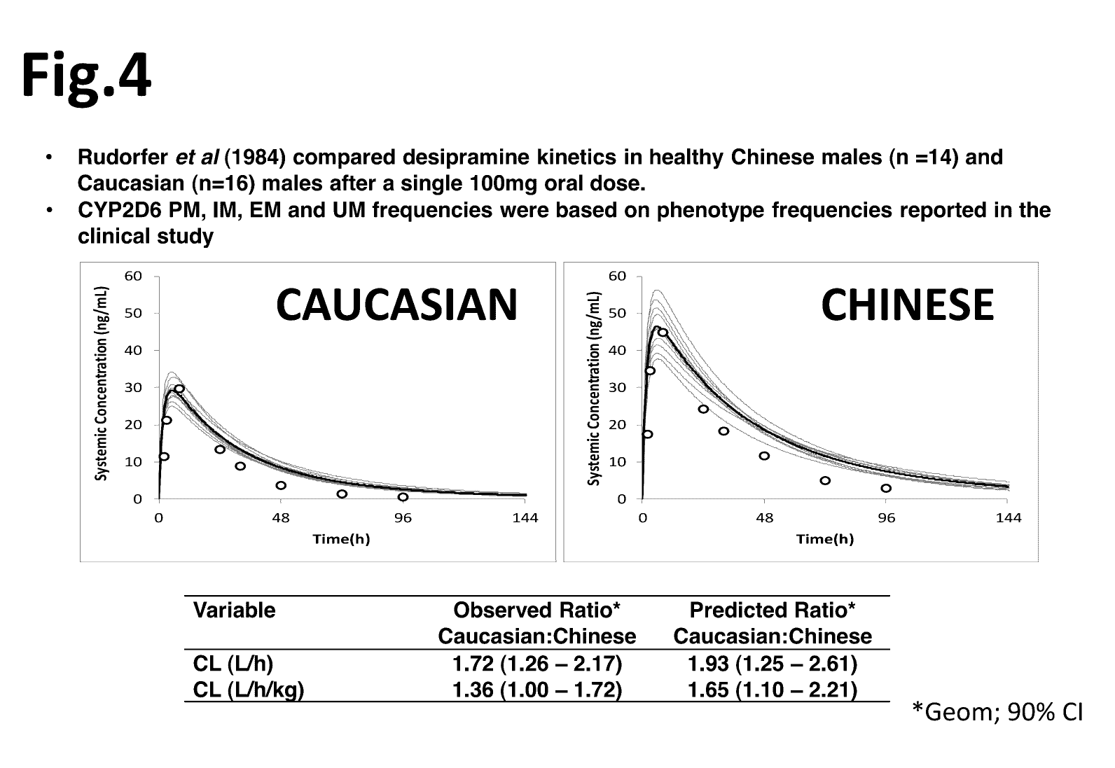

FIG. 5. A schematic indicating how the use of a computerized model can be implement to provide dosage guidance in individual patients (the ‘virtual twin’ concept), as an alternative to the conventional method of closing the therapeutic loop (see FIG. 1).

FIG. 6. A generic physiologically-based pharmacokinetic (PBPK) model (upper central panel, shown with sub-models for the disposition of drugs in the brain (upper left), kidney (upper right) and liver (bottom left) and the absorption of drugs from the gastrointestinal tract (lower central), as implemented in the Simcyp Simulator®.

FIG. 7. Simcyp Simulator Parameter Estimation module used to tune drug dose to reach required plasma drug concentration.

FIG. 8. Matching the real patient with their virtual twin

FIG. 9. A schematic illustrating the flow of implementation of the ‘virtual twin’ concept for drug dosage guidance at the point-of-care.

### DETAILED DESCRIPTION OF THE INVENTION

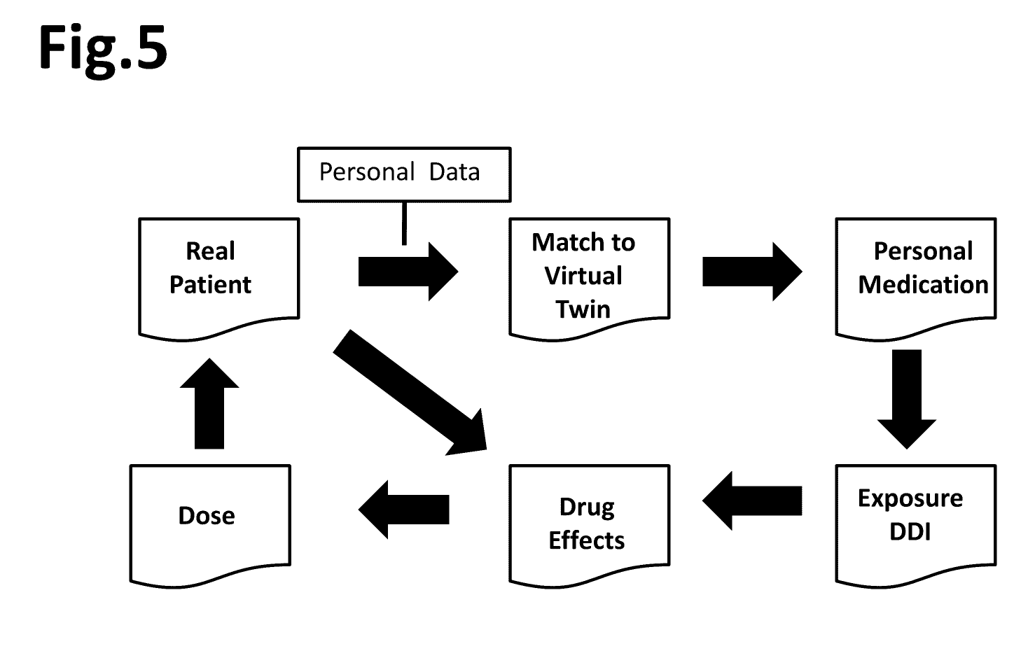

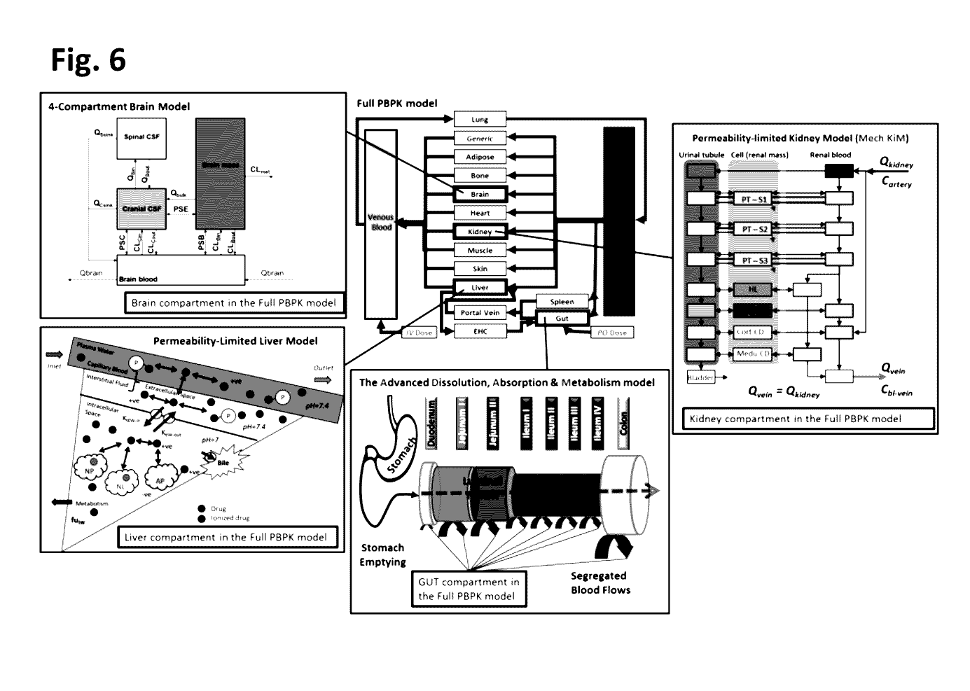

As described above, the Simcyp Simulator®, models drug behavior across defined populations to predict pharmacokinetic and pharmacodynamics outcomes. Every real world (non-virtual) patient belongs to at least one general population. The present method utilizes knowledge about the general population to which the patient belongs to predict relevant pharmacokinetic and pharmacodynamic outcomes for the patient. As an adjunct to the conventional dosage paradigm, the modified Simcyp Simulator method of the present invention provides point-of-care drug dosage guidance that can potentially both speed up the process and help to reduce the number of follow up visits and associated health care costs by means of an easy to use and validated computerized system. A matching of the demographic, physiological and genetic characteristics of a real patient with his or her ‘Virtual Twin™’ by the computer enabled by the present invention facilitates exploration of the likely impact of changes in organ function and co-medication with respect to the management of drug therapy, as an important step on the way to the goal of truly ‘personalized/stratified’ medicine (FIG. 5). The method employs a necessary computer program (The Simcyp Simulator) that utilizes a physiologically-based pharmacokinetic (PBPK) model linked to pharmacodynamic models of varying levels of sophistication (PBPK/PD). PBPK models are generic representations that describe and predict the time-course of drug concentrations in blood and tissues in a realistic way based on the interconnection of body organs by blood flow (11). Various sub-PBPK models allowing a more detailed evaluation of the fate of drugs in specific organs (e.g. brain, kidney, liver, gut) are nested within the overall model (FIG. 6).

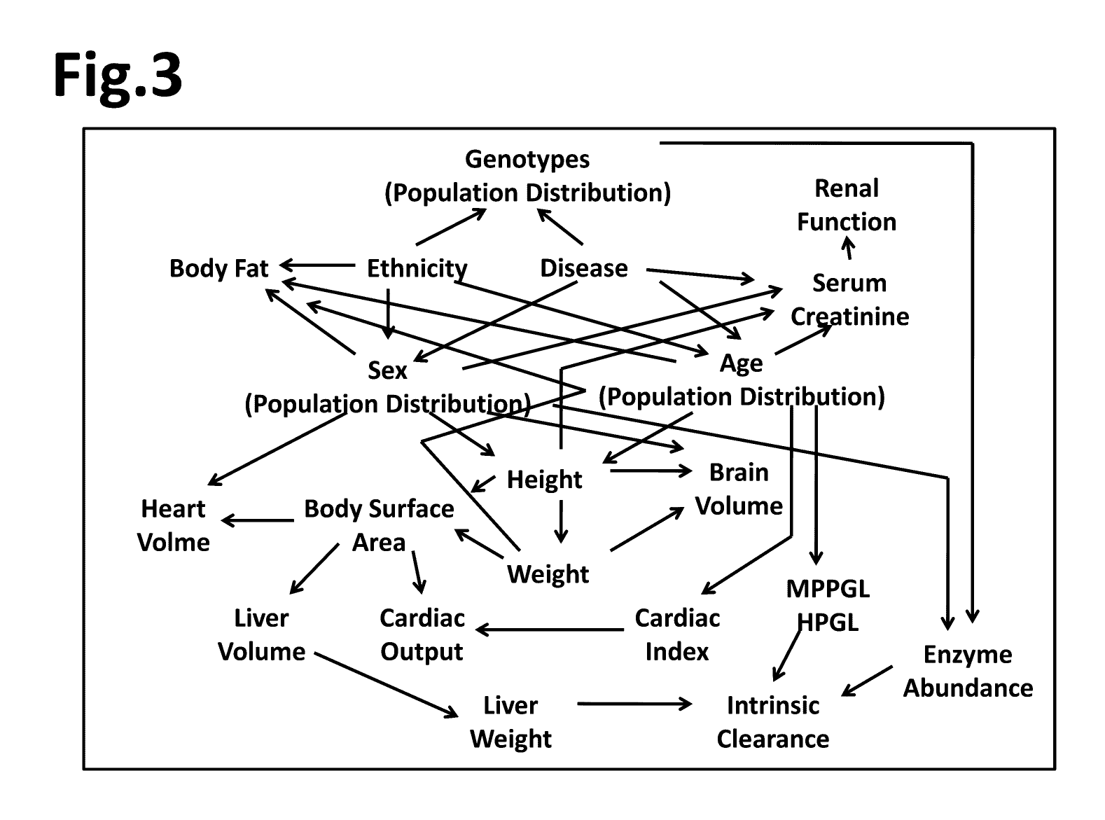

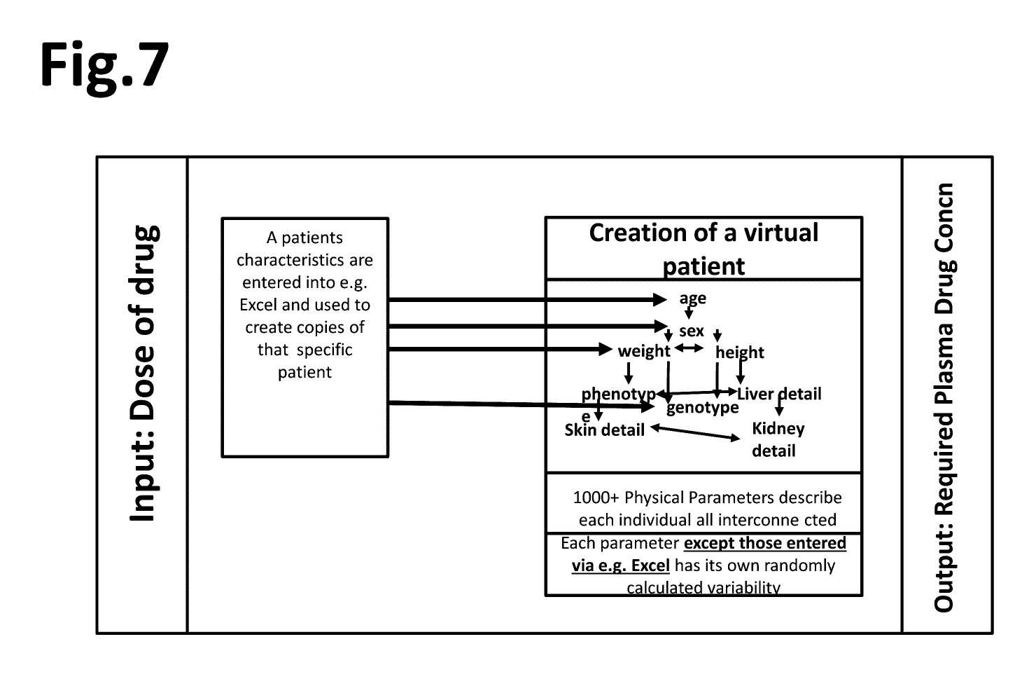

The present invention is a novel and unique extension of the Simcyp Simulator that utilizes the Simcyp Simulator® to predict a pharmacokinetic-pharmacodynamic outcome in individual subjects, rather than just populations as disclosed previously. Progression from the generation of a general population within the Simcyp Simulator to the generation of a Virtual Twin in the modified Simcyp Simulator of the present invention is described in the Appendix (FIG. 7). Isolation of characteristics specific to an individual is facilitated by the fact that the distributions of most of the system specific parameters of the PBPK models (e.g. tissue volumes and blood flow and, to some extent, enzyme and transporter tissue abundances) are linked directly to the demographics (FIG. 3). Other pertinent data, such as drug-specific enzyme and transporter activities, are less closely linked to patient demography. These data and their population distributions are available within the Simcyp Simulator®, and values of such parameters for an individual are determined by random selection from the population distributions of the values when patient specific data is not available. Thus, as far as possible, there is a honing down of parameter values likely to refer to a specific, real individual. Dosage predictions for that individual subject are provided with confidence limits consequent to those parameter values requiring repeat sampling from population distributions. Thus, provision of individual subject characterization within the Simcyp Simulator® results in the generation of what is referred to as a Virtual Twin™ in this patent document. This approach is especially useful when predicting the effects of the co-administration of more than two drugs to an individual patient at the same time. Thus, while information on the interaction of specific pairs of drugs is available from standard sources, the permutations of the likely quantitative outcome from administration of multiple drugs simultaneously can only be appreciated based on a detailed, physiologically-based computerized method.

The characteristics of the Virtual Twin™ are derived from data from a wider population of individuals, but they are specific to a given patient, combining all known factors for which there is sufficient usable data. At a high level, the systems and methods include the component steps and/or systems of population model generation, virtual twin generation from a population model based on input of information on the real patient, prediction of drug exposure and response, dosage in the individual patient, and recommendation of any dosage adjustment in that patient. In one embodiment, outcomes may be fed back into the population models to identify correlations, trends and the like.

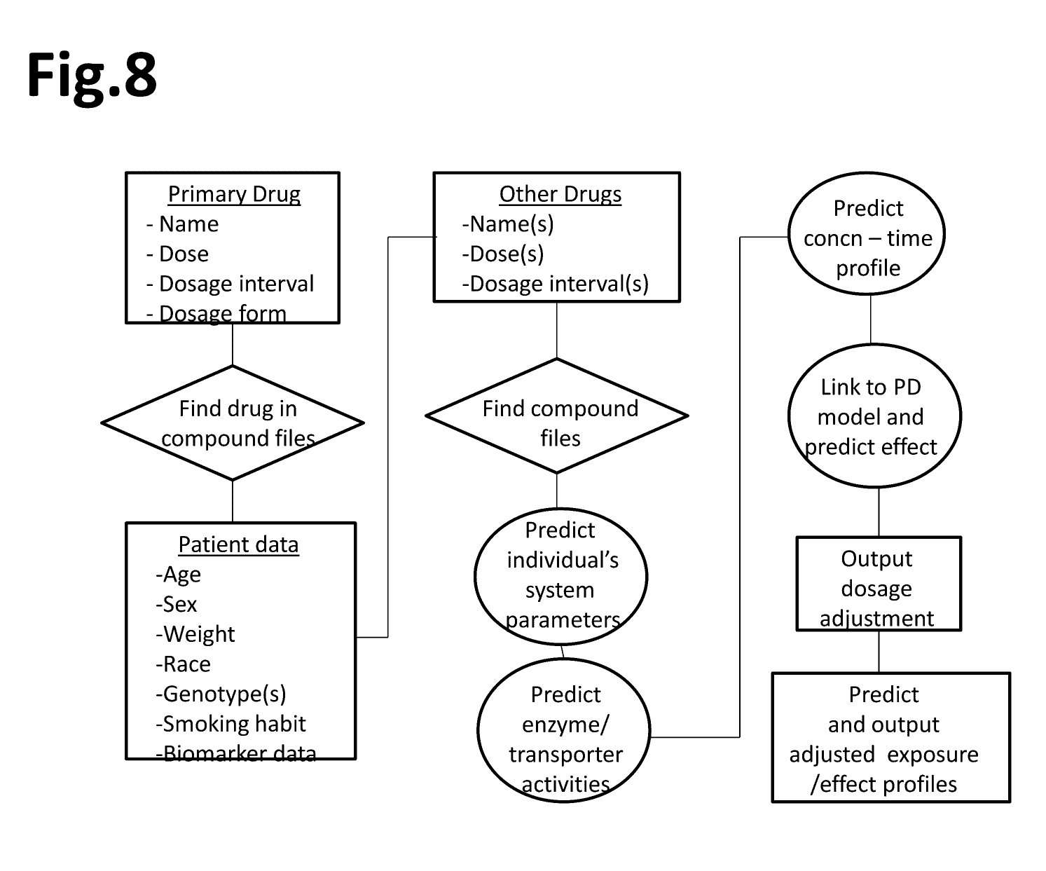

Matching the real patient with their Virtual Twin™ and predicting a safe and effective individualized dosing regimen is accomplished in the following steps (FIG. 8):

Step 1: Entry of a chosen dosage, dosage interval, route of administration, and dosage form (where relevant) for the drug of interest (the primary drug). The name of the drug is matched with the compound libraries within the Simulator to determine if a file for that drug has been established. If so, the next step is initiated.
Step 2: Entry of age, sex, weight, race of the patient and relevant genotypes (for enzymes and transporters, receptors), smoking habit (number of cigarettes smoked per day), and relevant biomarker data (e.g. markers of specific drug metabolizing enzyme activity—such as salivary caffeine level for CYP1A2, plasma 6 beta-hydroxycortisol level for CYP3A4). The user is also requested to enter the names of any other drugs (and their dosage) that the patient is already taking or that the doctor wishes them to take simultaneously with the primary drug. The names of these drugs are matched with compound libraries within the Simcyp Simulator® to determine if files for those drugs have been established. If so, the degree of any interaction with the primary drug is subsequently determined.
Step 3: Based on the patient's demographics and relevant information on disease state, the modified Simcyp Simulator® of the present invention is used to define his or her tissue volumes and blood flows, renal function, and gut characteristics (gastric emptying rate, segmental volumes and transit times, lumen pH and flows etc) with reference to population data embedded within the system.
Step 4: The modified Simcyp Simulator of the present invention is used to define the patient's relevant hepatic and intestinal metabolizing enzyme activities and organ uptake and efflux transporter activities based on individual demographics, genotypes, biomarker data, interacting medication, and the likely abundances of enzymes and transporters, together with values of specific scaling factors (e.g. hepatocellularity, milligrams of microsomal protein per gram of liver etc). Enzyme/transporter activities in the individual have associated variances inasmuch as not every determinant parameter has values specific to that patient's demographics and other input characteristics and are, therefore, provided as a range based on population data embedded in the Simulator.
Step 5: Using the pre-defined compound file for the drug of interest and those available for any interacting drugs, the modified Simulator is used to predict and plot the individual plasma drug concentration-time profile and its confidence limits for the chosen dosage regimen.
Step 6: The modified Simulator is used to link the predicted drug exposure profile to drug response with an appropriate pharmacodynamic model chosen from the suite of such models available in the Simulator. The simplest of such models is a threshold model based on the prior definition of a ‘therapeutic range’ of plasma concentrations of the drug of interest, This range defines a lower limit below which the majority of patients would be expected to have no response and an upper limit above which most patients would be expected to experience a degree of toxicity. Such ranges are documented in the literature for many commonly used drugs (e.g. the ‘therapeutic range’ of theophylline, an anti-asthmatic drug, is 5-10 micrograms per ml plasma). In alternative embodiments specific to the drug, more sophisticated pharmacodynamics models can be implemented, including linear, log linear, Eₘₐₓ, sigmoid Eₘₐₓ models, indirect and turnover models and complex stimulus-response models. (8) These models require further specific system and drug-related parameter values derived from literature sources. In yet another embodiment, disease progression models are linked to the PKPD models to assess, in conjunction with information on disease severity, likely longer-term clinical outcomes in the individual patient.
Step 7: The modified Simcyp Simulator of the present invention calculates and outputs any dosage adjustment necessary to maintain systemic drug exposure within the ‘therapeutic range’ or to reproduce systemic exposure in the absence of the interacting drugs. The precise predicted dosage is approximated for practical purposes according to the range of unit dosages and dosage forms available for the particular drug. The latter information is provided within each compound file in the Simulator.
Step 8: The modified Simcyp Simulator of the present invention outputs the individual plasma drug concentration-time profile and its confidence limits predicted for the new dosage regime in relation to the ‘therapeutic range’ or consistent with systemic exposure in the absence of the interacting drugs.

In yet another embodiment to this sequence of steps, the utilization of measurements of the plasma concentration of the drug of interest in the individual patient, based on a well-documented history of dosage and adherence to therapy, is integrated to inform further dosage adjustment through the application of Bayesian inference (12).

An example of the operation of the method of the present invention outlined in Steps 1-8 is provided by the following situation. Consider the dosage of olanzepine for the out-patient treatment of schizophrenia in a 29 year old, 70 kg, male Caucasian who is a heavy smoker. Olanzepine is eliminated mainly through metabolism by a variety of enzymes, but principally CYPs 1A2 and 3A4. The activity of CYP1A2 is increased in cigarette smokers in proportion to the number of cigarette smoked per day due to the effect of induction of the enzyme by hydrocarbons. The recommended oral dose of olanzapine is 5-20 mg per day. Response to the drug is highly variable, but a ‘therapeutic range’ of plasma drug concentrations of 20-80 ng/ml has been established. A dose of 20 mg/day is selected initially and this provides a reasonably satisfactory response, supported by the measurement of a sustained maximum plasma drug concentration of 65 ng/ml. However, the patient is to be admitted to a psychiatric unit for further investigation during which time he is no longer allowed to smoke. Entry of the available information into the Simulator indicates that a reduction in dosage to 10 mg/day would be prudent to avoid adverse effects as otherwise his plasma drug level is likely to rise above the toxic threshold as the level of induction of CYP1A2 decreases with withdrawal of cigarettes. While in hospital, the patient develops a fungal infection for which he is prescribed ketoconazole. This drug interacts with olanzepine by inhibiting its metabolism by CYP3A4. To offset this effect, the Simulator indicates that a further dosage adjustment downwards to 5 mg would be prudent to allow for a predicted further decrease in the clearance of olanzapine in the patient.

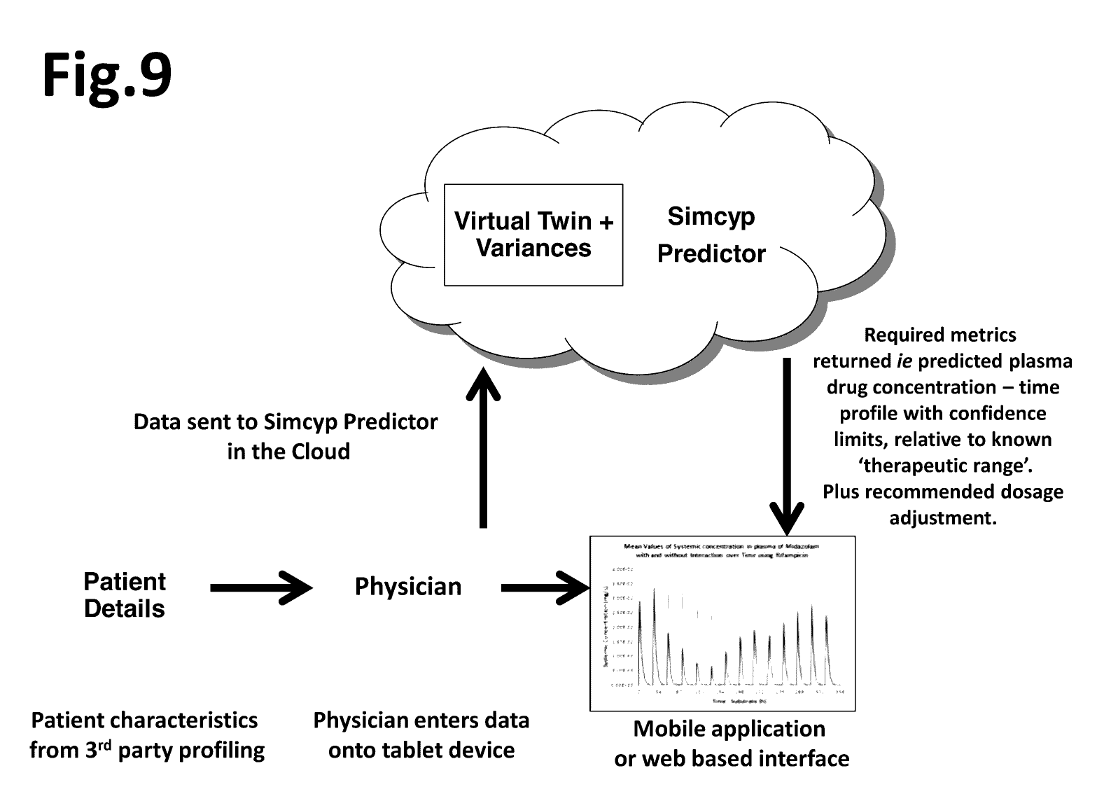

An illustration of how the software of the modified Simcyp Simulator matches the virtual and real patient and provides dosage guidance to be implemented at the point of clinical care is shown in FIG. 9. Available individual patient data relevant to the process are collated by the physician and/or clinical pharmacist either from the medical/laboratory notes or from an electronic medical records system. These data are entered into an electronic device such as a tablet, mobile phone or laptop or desktop computer listing specific drugs curated as Simcyp® compound files. In the depicted embodiment, the patient data and an indication of relevant compound files are then transmitted to a secure data center or service facility (ideally using the ‘cloud’ technology) over the Internet, with a request to generate a virtual twin and output a prediction of drug exposure in relation to effect, together with a recommended dosage regimen, using the Simcyp Simulator®. This guidance is then returned to the physician and/or clinical pharmacist on their mobile or other application. After PK or PD data are collected using the above methodology, these data can be used to update the Virtual Twin™ model, using the process described above, and the updated model used to determine if a subsequent modification to the patient's dose or regimen is required to facilitate the desired outcome in the patient.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

### APPENDIX

The method of using the Simcyp Simulator to create a virtual population within the Simulator uses parameter estimation. Rather than taking the mean parameter values for a large number of physiological points and then using the supplied variabilities (within the selected population) to generate a typical “real life” individual, a Parameter Estimation approach allows a user to enter the base parameters describing an individual (FIG. 9). The idea is that rather than creating a virtual population of individuals, the Simcyp Simulator is used to create a population based around the patient. The known patient parameters are used as seed parameters that are fixed and have no variability. All other unknown parameters are then calculated based on the magnitude of their relationship to the seeded parameters and then additional variability is added to generate a population of virtual patients based on the original presenting patient but with the unknown parameters covering the possible range of values seen in real life. This allows the boundaries of reaction to the compound to be simulated as well as the mean value.

The creation of a number of virtual patients sharing the same known characteristics but covering all unknown characteristics allows the calculation of plasma concentration levels in that patient with appropriate confidence ranges.

The Parameter Estimation method also allows the dose level of an administered drug to be calculated to enable a specific plasma concentration to be achieved. To do this the Simcyp Simulator is used to create the virtual patients in the manner described above and then performs a Parameter Estimation to back calculate the necessary dose to reach the concentration level required.

Specifically, the Parameter Estimation determines the values of the parameters, θᵢ, by minimising the value of the errors for each observation. This is achieved by defining an objective function, which is a measure of the overall difference between the predicted model outcome and the observed dependent variable for all individuals and observations. An optimization algorithm is then used to determine the parameter estimates that minimize this objective function.

### REFERENCES

1. wwwforbes.com/ . . . /1-in-3-american-adults-take-prescription-drugs/.
2. Tucker G T: Clinical implications of genetic polymorphism in drug metabolism. J Pharm. Pharmacol. 46: 417-24, 1994.
3. Leendertse A J, Egberts A C G, Stoker L J, van den Bernt PMLA, for the HARM Study Group: Frequency and risk factors for preventable medication-related hospital admissions in the Netherlands. Arch, Int. Med. 168: 1890-96, 2008.
4. Davies E C, Green C F, Taylor S, Williamson P R, Mottram D R et al: Adverse drug reactions in hospital in-patients: A prospective analysis of 3695 patient episodes. PLoS ONE 4(2): e4439.doi:10.1371/journal.pone.000443.
5. Jamei M, Marciniak S, Feng K, Barnett A, Tucker G T, Rostami-Hodjegan A: The Simcyp® Population-based ADME Simulator. Expert Opin. Drug Metab. Toxicol 5: 211-23, 2009.
6. Jamei M, Marciniak S, Edwards D, Wragg K, Feng K, Barnett A, Rostami-Hodjegan A: The Simcyp Population Based Simulator: Architecture, implementation, and quality assurance. In Silico Pharmacology 1: 1-14, 2013 (doi:10.1186/2193-9616-1-9).
7. Ahamadi M, Kingsley E, Machavaram K, Turner D: A guide for IVIVE and PBPK modelling using the Simcyp Population-based ADME Simulator. Simcyp Ltd, 2010.
8. Gabrielsson J, Weiner D: Pharmacokinetic & Pharmacodyamic Data Analysis: Concepts and Applications. 4th Edition. Swedish Pharmaceutical Press, Stockholm, 2006.
9. Polak S, Fijorek K, Glinka A, Wisniowska B, Mendyk A: Virtual population generator for human cardiomyocytes parameters: In silico drug cardiotoxicity assessment. Toxicology Mechanisms and Methods 22: 31-40, 2012.
10. Barter Z E, Tucker G T, Rowland-Yeo, K: Differences in cytochrome P450-mediated pharmacokinetics between Chinese and Caucasian populations predicted by mechanistic physiologically-based pharmacokinetic modelling. Clin Pharmacokinetics 52: 1085-1100, 2013.
11. Rowland M, Peck C and Tucker G: Physiologically-based pharmacokinetics in drug development and regulatory science. Annu. Rev. Pharmacol. Toxicol. 51: 45-73, 2011.
12. Jelliffe R, Schumitzky A, vanGuilder M: Population pharmacokinetic/pharmacodynamics modelling: Parametric and non-parametric methods. Ther. Drug Monit. 22: 354-65, 2000.

We claim:

1. A method of using the Simcyp Simulator to identify a Virtual Twin to a real patient to identify drug treatment parameters and possible drug interactions comprising the following steps:
entering a chosen dosage, dosage interval, route of administration, and dosage form (where relevant) for the drug of interest (the primary drug). The name of the drug is matched with the compound libraries within the Simulator to determine if a file for that drug has been established. If so, the next step will be initiated;
b) entering age, sex, weight, race of the patient and relevant genotypes (for enzymes and transporters, receptors), smoking habit (number of cigarettes smoked per day), and relevant biomarker data (e.g. markers of specific drug metabolizing enzyme activity—such as salivary caffeine level for CYP1A2, plasma 6 beta-hydroxycortisol level for CYP3A4). The prescriber is also requested to enter the names of any other drugs (and their dosage) that the patient is already taking or that the doctor wishes them to take simultaneously with the primary drug. The names of these drugs are matched with compound libraries within the Simcyp Simulator® to determine if files for those drugs have been established. If so, the degree of any interaction with the primary drug will subsequently be determined;
c) determining on the patient's demographics and relevant information on disease state, the Simcyp Simulator® defines his or her tissue volumes and blood flows, renal function, and gut characteristics (gastric emptying rate, segmental volumes and transit times, lumen pH and flows etc) with reference to population data embedded within the system;
d) defining the patient's relevant hepatic and intestinal metabolizing enzyme activities and organ uptake and efflux transporter activities based on individual demographics, genotypes, biomarker data, interacting medication, and the likely abundances of enzymes and transporters, together with values of specific scaling factors (e.g. hepatocellularity, milligrams of microsomal protein per gram of liver etc). Enzyme/transporter activities in the individual will have associated variances inasmuch as not every determinant parameter will have values specific to that patient's demographics and other input characteristics and will, therefore, be provided as a range based on population data embedded in the Simulator;
e) using the pre-defined compound file for the drug of interest and those available for any interacting drugs, the Simulator predicts and plots the individual plasma drug concentration-time profile and its confidence limits for the chosen dosage regimen;
f) linking the predicted drug exposure profile to drug response with an appropriate pharmacodynamic model chosen from the suite of such models available in the Simulator. The simplest of such models is a threshold model based on the prior definition of a ‘therapeutic range’ of plasma concentrations of the drug of interest, This range defines a lower limit below which the majority of patients would be expected to have no response and an upper limit above which most patients would be expected to experience a degree of toxicity. Such ranges are documented in the literature for many commonly used drugs (e.g. the ‘therapeutic range’ of theophylline, an anti-asthmatic drug, is 5-10 micrograms per ml plasma). Specific to the drug, more sophisticated pharmacodynamics models can be implemented, including linear, log linear, Eₘₐₓ, sigmoid Eₘₐₓ models, indirect and turnover models and complex stimulus-response models. (Gahrielsson & Weiner, 2006) These models require further specific system and drug-related parameter values derived from literature sources. In addition, disease progression models can be linked to the PKPD models to assess, in conjunction with information on disease severity, likely longer-term clinical outcomes in the individual patient;
g) calculating and outputting any dosage adjustment necessary to maintain systemic drug exposure within the ‘therapeutic range’ or to reproduce systemic exposure in the absence of the interacting drugs; and
h) outputting the individual plasma drug concentration-time profile and its confidence limits predicted for the new dosage regime in relation to the ‘therapeutic range’ or consistent with systemic exposure in the absence of the interacting drugs.

2. A method of determining drug treatment parameters and possible drug interactions for a patient undergoing treatment comprising the following steps:
a) creating a database structure and database containing pharmacokinetic and pharmacodynamic data on one or more populations;
b) obtaining demographic data, physiological characteristics, disease state, habits effecting health, and genetic characteristics of the patient;
c) obtaining a list of drugs and drug dosages that are taken by the patient;
d) inputting the patient data into a computer program that compares/matches the individual patient characteristics to the population characteristics of the population to which the patient belongs;
e) predicting and plotting likely range of drug plasma concentrations in the patient; and
f) outputting any dosage adjustment required for the patient to avoid under or over dosing the patient in addition to identifying any interference between drugs the patient may be given

3. A computer implemented system of determining drug treatment parameters and possible drug interactions for a patient undergoing treatment comprising the following steps:
a) creating in a computer a database structure and database containing pharmacokinetic and pharmacodynamic data on one or more populations;
b) obtaining demographic data, physiological characteristics, disease state, habits effecting health, and genetic characteristics of the patient;
c) obtaining a list of drugs and drug dosages that are taken by the patient;
d) inputting the patient data into a computer program that compares/matches the individual patient characteristics to the population characteristics of the population to which the patient belongs;
e) predicting and plotting likely range of drug plasma concentrations in the patient; and
f) outputting any dosage adjustment required for the patient to avoid under or over dosing the patient in addition to identifying any interference between drugs the patient may be given.

4. The method of claim 2 in which the computer program is the Simcyp Simulator.

5. The system of claim 3 in which the computer program is the Simcyp Simulator.

6. A computer implemented system using the Simcyp Simulator to identify a Virtual Twin to a real patient to identify drug treatment parameters and possible drug interactions comprising the following steps:
entering a chosen dosage, dosage interval, route of administration, and dosage form (where relevant) for the drug of interest (the primary drug). The name of the drug is matched with the compound libraries within the Simulator to determine if a file for that drug has been established. If so, the next step will be initiated;
b) entering age, sex, weight, race of the patient and relevant genotypes (for enzymes and transporters, receptors), smoking habit (number of cigarettes smoked per day), and relevant biomarker data (e.g. markers of specific drug metabolizing enzyme activity—such as salivary caffeine level for CYP1A2, plasma 6 beta-hydroxycortisol level for CYP3A4). The prescriber is also requested to enter the names of any other drugs (and their dosage) that the patient is already taking or that the doctor wishes them to take simultaneously with the primary drug. The names of these drugs are matched with compound libraries within the Simcyp Simulator® to determine if files for those drugs have been established. If so, the degree of any interaction with the primary drug will subsequently be determined;
c) determining on the patient's demographics and relevant information on disease state, the Simcyp Simulator® defines his or her tissue volumes and blood flows, renal function, and gut characteristics (gastric emptying rate, segmental volumes and transit times, lumen pH and flows etc) with reference to population data embedded within the system;
d) defining the patient's relevant hepatic and intestinal metabolizing enzyme activities and organ uptake and efflux transporter activities based on individual demographics, genotypes, biomarker data, interacting medication, and the likely abundances of enzymes and transporters, together with values of specific scaling factors (e.g. hepatocellularity, milligrams of microsomal protein per gram of liver etc). Enzyme/transporter activities in the individual will have associated variances inasmuch as not every determinant parameter will have values specific to that patient's demographics and other input characteristics and will, therefore, be provided as a range based on population data embedded in the Simulator;
e) using the pre-defined compound file for the drug of interest and those available for any interacting drugs, the Simulator predicts and plots the individual plasma drug concentration-time profile and its confidence limits for the chosen dosage regimen;
f) linking the predicted drug exposure profile to drug response with an appropriate pharmacodynamic model chosen from the suite of such models available in the Simulator. The simplest of such models is a threshold model based on the prior definition of a ‘therapeutic range’ of plasma concentrations of the drug of interest, This range defines a lower limit below which the majority of patients would be expected to have no response and an upper limit above which most patients would be expected to experience a degree of toxicity. Such ranges are documented in the literature for many commonly used drugs (e.g. the ‘therapeutic range’ of theophylline, an anti-asthmatic drug, is 5-10 micrograms per ml plasma). Specific to the drug, more sophisticated pharmacodynamics models can be implemented, including linear, log linear, Eₘₐₓ, sigmoid Eₘₐₓ models, indirect and turnover models and complex stimulus-response models. (Gabrielsson & Weiner, 2006) These models require further specific system and drug-related parameter values derived from literature sources. In addition, disease progression models can be linked to the PKPD models to assess, in conjunction with information on disease severity, likely longer-term clinical outcomes in the individual patient;
g) calculating and outputting any dosage adjustment necessary to maintain systemic drug exposure within the ‘therapeutic range’ or to reproduce systemic exposure in the absence of the interacting drugs; and
h) outputting the individual plasma drug concentration-time profile and its confidence limits predicted for the new dosage regime in relation to the ‘therapeutic range’ or consistent with systemic exposure in the absence of the interacting drugs.
